(19) United States
(12) Patent Application Publication
(10) Pub. No.: US 2005/0243087 A1
(43) Pub. Date: Nov. 3, 2005

(54) GPU-based Finite Element

(76) Inventor: Shmuel Aharon, West Windsor, NJ (US)

Correspondence Address: SIEMENS CORPORATION;INTELLECTUAL PROPERTY DEPARTMENT, 170 WOOD AVENUE SOUTH, ISELIN, NJ, 08830, US

(21) Appl. No.: 11/115,642

(22) Filed: Apr. 27, 2005

Related U.S. Application Data
(60) Provisional application No. 60/567,063, filed on Apr. 30, 2004.

(51) Int. Cl. G06T 17/00; G06F 17/50

(52) U.S. Cl. 345/420

(57) ABSTRACT

Exemplary methods and systems are provided for performing the Finite Element Method. An exemplary method includes the steps of transferring a set of nodes and elements (i.e., a mesh) from a memory to a graphics processing unit (GPU); and performing the Finite Element Method on the set of nodes and elements using only the GPU. An exemplary system includes a central processing unit (CPU); a memory operatively connected to the CPU; and a graphics processing unit (GPU) operatively connected to the CPU; wherein the CPU transfers a set of nodes and elements from the memory to the GPU; and wherein the GPU performs the Finite Element Method on the set of nodes and elements.

### CROSS-REFERENCE TO RELATED APPLICATIONS

This application claims priority to U.S. Provisional Application No. 60/567,063, which was filed on Apr. 30, 2004, and which is fully incorporated herein by reference.

### BACKGROUND OF THE INVENTION

1. Field of the Invention

The present invention relates generally to the field of physical systems modeling, and, more particularly, to performing finite element calculation on a programmable graphical processing unit (GPU).

2. Description of the Related Art

The field of physical systems modeling generally involves creating mathematical models of physical reality. Such models may be useful in a wide variety of fields, including engineering, science and applied mathematics. A powerful tool for modeling physical systems is the Finite Element Method (“FEM”).

In substantially simplified terms, the FEM involves (a) taking a “big” domain a problem is defined on, (b) dividing the big domain into several “small” sub-domains, called elements, (c) transforming the problem's equation, for each of the small sub-domains (i.e., elements), into algebraic form (element matrix), (d) assembling the algebraic equations from all of the small sub domains into a “big” linear system of equations for the entire domain (global matrix), and (e) solving the system of equations to receive the desired solution to the problem over the entire “big” domain.

The FEM can be computationally expensive and extremely demanding on memory and other computing resources to get appropriate numerical accuracy.

### SUMMARY OF THE INVENTION

In one aspect of the present invention, a computer-implemented method for performing the Finite Element Method is provided. The method includes the steps of receiving a mesh defined as a set of nodes and elements; storing the coordinates on a graphics processing unit (GPU), the coordinates corresponding to each node in the set of nodes; storing the elements connectivity information on the GPU, the elements connectivity information for the elements; forming a first matrix for each of the elements based on the corresponding coordinates and the elements connectivity information; forming a second matrix for each of the elements based on corresponding material properties; determining a left-hand side of a system of equations for each of the elements, the left-hand side comprising an element matrix based on a sum of the products of a transpose of the first matrix, the second matrix, and the first matrix; determining a right-hand side of the system of equations for the each of the elements based on boundary conditions, wherein the left hand-side and the right hand side for all of the elements form a global system; eliminating values corresponding to known boundary conditions from the global system using a Z-buffer mask; and solving the global system.

In another aspect of the present invention, a system for performing the Finite Element Method is provided. The system includes a central processing unit (CPU); a memory operatively connected to the CPU; and a graphics processing unit (GPU) operatively connected to the CPU; wherein the CPU transfers a set of nodes and elements from the memory to the GPU, the set of nodes and the elements forming a mesh; and wherein the GPU performs the Finite Element Method on the set of nodes and the elements.

In yet another aspect of the present invention, a program storage device readable by a machine, tangibly embodying a program of instructions executable on the machine to perform method steps for performing the Finite Element Method, is provided. The method includes the steps of transferring a set of nodes and elements from a memory to a graphics processing unit (GPU), the set of nodes and the elements forming a mesh; and performing the Finite Element Method on the set of nodes and the elements using only the GPU.

### BRIEF DESCRIPTION OF THE DRAWINGS

The invention may be understood by reference to the following description taken in conjunction with the accompanying drawings, in which like reference numerals identify like elements, and in which:

FIG. 1 depicts an exemplary reduce operation;

FIG. 2 depicts a flow diagram illustrating an exemplary method for performing the Finite Element Method;

FIG. 3 depicts a representation of triangular element connectivity in RGB texture, in accordance with one exemplary embodiment of the present invention;

FIG. 4 depicts a flow diagram illustrating a method for performing the Finite Element Method, in accordance with one exemplary embodiment of the present invention; and

FIG. 5 depicts a block diagram illustrating a system for performing the Finite Element Method, in accordance with one exemplary embodiment of the present invention.

### DETAILED DESCRIPTION OF PREFERRED EMBODIMENTS

Illustrative embodiments of the invention are described below. In the interest of clarity, not all features of an actual implementation are described in this specification. It will of course be appreciated that in the development of any such actual embodiment, numerous implementation-specific decisions must be made to achieve the developers' specific goals, such as compliance with system-related and business-related constraints, which will vary from one implementation to another. Moreover, it will be appreciated that such a development effort might be complex and time-consuming, but would nevertheless be a routine undertaking for those of ordinary skill in the art having the benefit of this disclosure.

While the invention is susceptible to various modifications and alternative forms, specific embodiments thereof have been shown by way of example in the drawings and are herein described in detail. It should be understood, however, that the description herein of specific embodiments is not intended to limit the invention to the particular forms disclosed, but on the contrary, the intention is to cover all modifications, equivalents, and alternatives falling within the spirit and scope of the invention as defined by the appended claims.

It is to be understood that the systems and methods described herein may be implemented in various forms of hardware, software, firmware, special purpose processors, or a combination thereof. In particular, at least a portion of the present invention is preferably implemented as an application comprising program instructions that are tangibly embodied on one or more program storage devices (e.g., hard disk, magnetic floppy disk, RAM, ROM, CD ROM, etc.) and executable by any device or machine comprising suitable architecture, such as a general purpose digital computer having a processor, memory, and input/output interfaces. It is to be further understood that, because some of the constituent system components and process steps depicted in the accompanying Figures are preferably implemented in software, the connections between system modules (or the logic flow of method steps) may differ depending upon the manner in which the present invention is programmed. Given the teachings herein, one of ordinary skill in the related art will be able to contemplate these and similar implementations of the present invention.

We present novel methods and systems for performing FEM on a programmable graphical processing unit (“GPU”). By leveraging the parallel processing capabilities of modern programmable GPUs, FEM can be performed significantly faster than with traditional implementations using only, for example, the central processing unit (“CPU”). Additionally, the GPU, as its name suggests, can provide powerful graphics processing capabilities. By collocating FEM computation with visualization of the FEM on the GPU, transferring data across the system bus to the GPU becomes unnecessary, allowing for faster visualization and interaction. That is, if the FEM calculation is done on the CPU, one has to transfer the results of the calculations to the GPU for display purposes. Examples of such data include new positions of nodes in elasticity problems, temperature values in heat transfer problem, and the like.

For illustrative purposes, we present herein an exemplary pure GPU-based approach to FEM. That is, the CPU is virtually idle during the entire computation process, and there is almost no data transfer from or to graphics memory during FEM computation in the GPU. The term “graphics memory” refers to the GPU memory. Graphics memory is distinguished from the CPU memory and is generally much more limited than the CPU memory. It should be appreciated that the transfer of data between GPU and CPU memory is a relatively time consuming operation that can reduce interactivity. Nevertheless, it should further be appreciated that a hybrid approach between the GPU and CPU can be implemented as well, as contemplated by those skilled in the art.

A graphics card/board can provide the ability to perform computations necessary for the rendering of 3D images (e.g., shading, lighting, texturing) directly on its GPU, thereby leaving the system's CPU available for other tasks. With a large 3D-gaming community demanding ever increasing frame rates and more sophisticated visual effects, many modern GPUs have higher overall performance than the fastest consumer-level CPUs. Further, the fast evolution of graphics processors from fixed function pipelines towards fully programmable floating point pipelines opens the opportunity to use the GPU as a fast vector processor. Additional features of modern GPUs include floating-point textures, render to (multiple) textures, programmable pixel units using shaders with arithmetic instructions and random access to texture data, parallelism in calculations (SIMD instructions) by four values per texture element (RGBA), and parallelism of pixel units (up to 16).

A. General-Purpose GPU Programming

We now describe how to use the GPU for tasks other than rendering images. General-purpose GPU programmers can map various types of processes to the special architecture of GPUs. The following sub-sections discuss textures as data storage and the update process, such as described by Krüeger et al., Linear Algebra Operators for GPU Implementation of Numerical Algorithms. ACM SIGGRAPH 2003: 27-31 Jul. 2003, San Diego, Calif., the disclosure of which is fully incorporated herein by reference.

A-1. Floating-Point Textures and Precision

Modern graphics cards allocate textures with floating-point precision in each texel (i.e., texture element). For illustrative purposes, the term “texture” refers to two-dimensional (“2D”) textures. It should be appreciated that one-dimensional and three-dimensional textures can be created as well, as contemplated by those skilled in the art. However, one-dimensional textures may result in performance disadvantages, and three-dimensional textures may result in update disadvantages.

A texture is a two-dimensional array of floating-point values. Each array element (i.e., texel) can hold up to four values. A texture may be used on the GPU as data structure for storing vectors or matrices.

The latest graphics cards by NVIDIA® and ATI® offer 32-bits and 24-bits of floating-point precision, respectively. While NVIDIA® cards tend to be more accurate, ATI® cards can be much faster. However, neither floating-point implementation is IEEE compliant (i.e., the IEEE standard for floating points description on CPUs).

A-2. Textures as Render Target and Shader Programs

Values in a texture can be updated by setting the texture as a render target and by rendering a quadrilateral orthogonal onto the texture. The term “render target” refers to the texture that is rendered to (i.e., a GPU operation). A shader program may be used to calculate and write the results of the rendering into the texture. The quadrilateral orthogonal covers the part of the texture to be updated.

For each covered texel, a pixel shader program may be executed to update the texel. Examples of pixel-shader programs include high-level shader language (“HLSL”), C for graphics (“Cg”), and OpenGL shading language (“GLSL”). Pixel shader programs can sample other input textures with random access, perform arithmetic operations, and provide dynamic branching in control flow. There is a hard limit on the number of instructions one can have in a shader program. The higher the shader version, the larger the number of instructions is possible.

A-3. Basic Operations on Textures

Operations on textures like element-wise addition and multiplication are the basic building blocks in numerous general-purpose GPU implementations. Input textures can be bound to sampler units, constants may be passed to the GPU, and an output texture must be set to store the results.

The following exemplary code (in HLSL) shows an exemplary method for multiplying the corresponding components of two textures. The pixel shader program samples both input textures, performs the arithmetical operation, and returns the result at each pixel location.

```
float4 psMultiply(PosTex v) : COLOR {
        float4 v0 = tex2D(sam0, v.TexCoords);
        float4 v1 = tex2D(sam1, v.TexCoords);
        return v0 * v1;
}
```

More advanced calculations on the GPU, such as the calculation of image gradients in shaders, are also possible, as contemplated by those skilled in the art.

A-4. Reduce Operation

One important operation for numerical computations is called the reduce operation. A reduce operation can find the maximum, minimum and average of all values in a texture. The reduce operation can also find the sum of all values in a texture. The sum may be used, for example, to calculate a dot product if two vectors are stored as a texture.

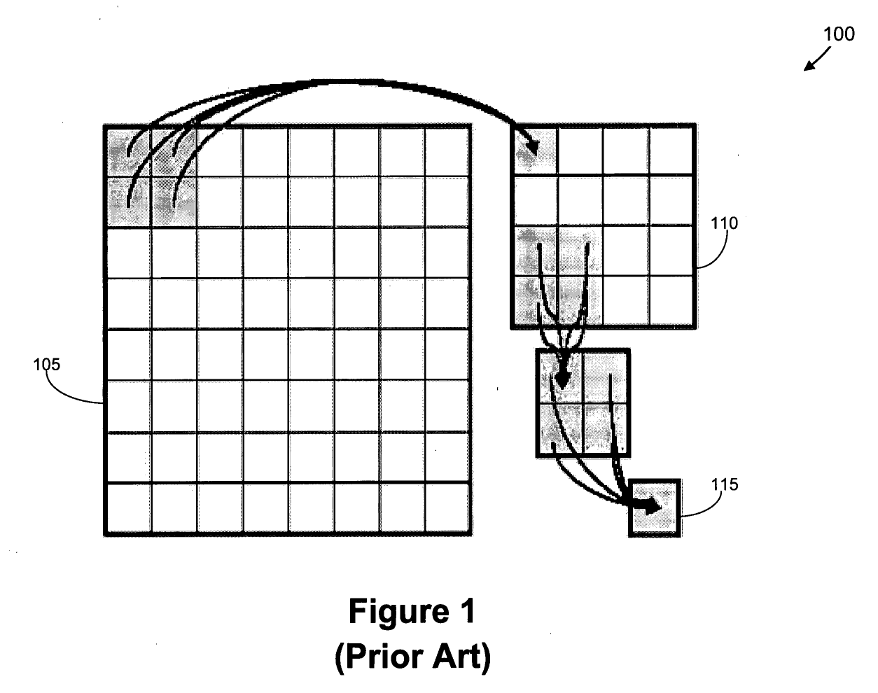

Referring now to FIG. 1, an exemplary reduce operation 100 is shown. The reduce operation 100 takes the original N×N texture 105 and performs the sum/average/minimum/maximum operation on each 2×2 block while rendering a second texture 110 of N/2×N/2. Four values in the original texture 105 are combined to a new one in the smaller, second texture 110. This procedure is repeated until the render target is a third 1×1 texture 115 that contains the final result. If the original texture width and height N is a power of two, a complete reduce chain comprises log N rendering passes until the result can be fetched.

The above-described reduce operation may be implemented using a ping-pong buffer alternating two textures, A and B, as read/write targets, as described in Krüger et al., Linear Algebra Operators for GPU Implementation of Numerical Algorithms. ACM SIGGRAPH 2003: 27-31 Jul. 2003, San Diego, Calif. In one pass, texture A may be used as render target and texture B may be set as input data; roles can be reversed in the following pass.

It should be appreciated that, instead of combining 2×2 areas to an output value, a larger area, such as a 4×4 area, can be used, as contemplated by those skilled in the art.

A-5. Vectors

Representing a 1D vector as a 2D texture may not appear intuitive, but may have performance advantages. The 1D vector data is filled into a 2D texture linearly. We put four vectors into one texture to fill the RGBA channels (i.e., the channels of a texture that the GPU operates on).

The dot product of two vectors is calculated by multiplying a corresponding vector component storing the multiplication results in an output texture followed by a reduce operation to sum all the multiplied components together.

A-6. Masking

A GPU-based process may require certain components (i.e., parts) of a texture to be unchanged while updating the rest of the components. To avoid defining a complicated geometry to mask out the unchanged components, a Z-buffer can used to mask out arbitrary regions. This requires the Z-buffer to be at least as large as the texture. Depending on the Z-test function, the components to be updated are set to 1 and the components to be unchanged to 0, or vice versa. The Z-test function compares the Z value of the incoming pixel to a pixel of the render target to determine whether the incoming pixel is rendered or discarded. Z-tests can be any of the following comparison tests: <, ≦, =, ≧, >.

Rendering a quadrilateral in the z=0.5 plane will prevent pixels in masked regions from entering the pixel pipeline. These pixels are discarded immediately instead of blocking the pipeline.

To take advantage of the 4-channel parallelism on GPUs, there are several ways to pack the data. One option is to pack an N×N texture (with one channel) into a N/2×N/2 texture with four channels, such as proposed by Krüger et al., Linear Algebra Operators for GPU Implementation of Numerical Algorithms. ACM SIGGRAPH 2003: 27-31 Jul. 2003, San Diego, Calif. However, this approach requires additional packing and unpacking passes, and the Z-buffer cannot be used as a mask anymore. An alternate option, as described in section A-5 above, is to store 4 different vectors in one texture using the RGBA channels—one for each vector. This method does not require packing and unpacking passes and the use of the Z-buffer for masking operation is possible.

B. GPU Finite Element Implementation

We now describe how to map and perform the FEM equations on the GPU. The formation of the FEM 2D quasi-static heat transfer equations, using triangular elements, is used solely for illustrative purposes. It should be appreciated that the method described here can be used with minor, straightforward modifications for solving any of a variety of FEM equations of different element types in either two-dimensions or three-dimensions, as contemplated by those skilled in the art.

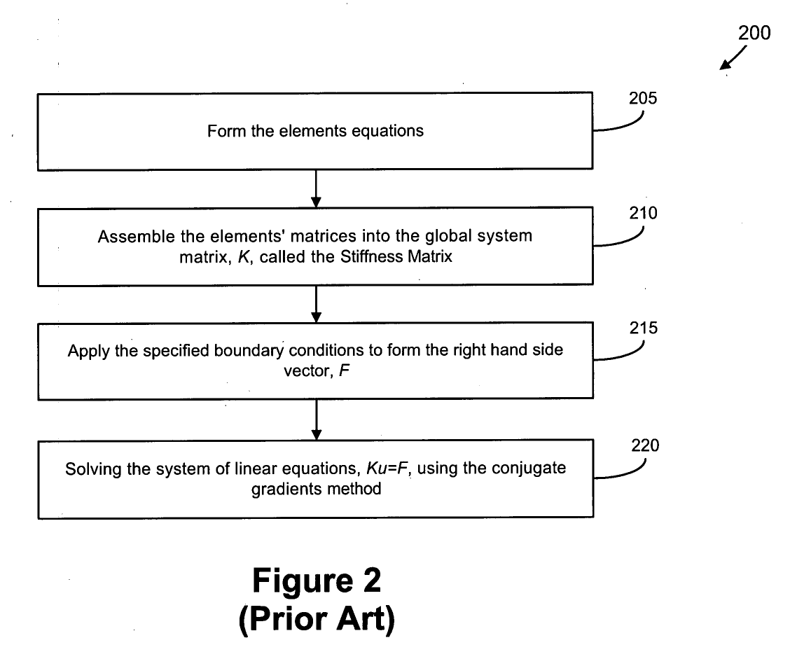

Referring now to FIG. 2, the finite element method 200 may be performed in four steps:
(1) Forming (at 205) the elements equations. That is, calculating the elements' matrices.
(2) Assembling (at 210) the elements' matrices into the global system matrix, K, called the Stiffness Matrix.
(3) Applying (at 215) the specified boundary conditions to form the right hand side vector, F.
(4) Solving (at 220) the system of linear equations, Ku=F, using the conjugate gradients method, such as described in Golub et al., Matrix Computations, 3rd ed. The Johns Hopkins University Press, 1996, the disclosure of which is fully incorporated herein by reference.

B-1. Nodes and Elements Definitions

The nodes coordinates are stored on the GPU in a floating-point RGB texture, which we refer to as the “nodes' coordinates texture.” The elements connectivity information is stored on the GPU in a RGB or RGBA texture(s), according to the element's number of nodes. A parameter specifying the number of texels per element is passed as a parameter to the GPU shaders.

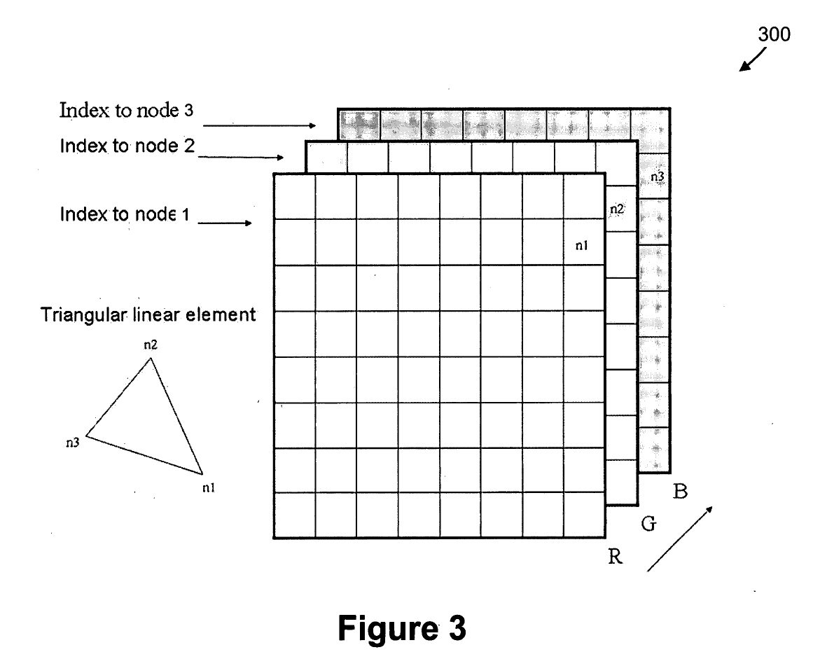

For example, the elements connectivity for triangular 2D linear elements are stored in a RGB texture, as shown in FIG. 3. Element connectivity refers to the indexes to the nodes forming each element. FIG. 3 shows an exemplary representation of a triangular linear element in an RGB texture. The number of pixels in the RGB texture is the same as the number of triangular linear elements. For each of the triangular linear elements, the RGB values of the corresponding pixel in the RGB texture, are the indexes (i.e., numbers) of the nodes forming this element. The node's (x, y, z) coordinates can be retrieved from the corresponding pixel in the nodes coordinates texture.

B.2 Forming the Elements' Matrices

The elements' stiffness matrix, K^{e}, is given by,

$${K}^{e} = {\int }_{e} {B}^{T} C B ⅆ e$$

where de refers to integrating over the element volume (or surface in 2D), C refers to a matrix containing the appropriate material thermal conductivity properties, and B refers to a matrix that is formed from the relative derivatives of the shape functions according to the coordinate systems. Additional information of the elements' stiffness matrix, which is known to those skilled in the art, may be provided by Zienkiewicz et al. 2000. The Finite Element Method, vol. 1, published by CIMNE, the International Centre for Numerical Methods in Engineering, Barcelona, Spain, the disclosure of which is fully incorporated herein by reference.

For example, for a 2D heat transfer problem using triangular linear elements, C is a 2×2 matrix, and B is 2×3 matrix that is given by,

$$B = [ \begin{matrix}\frac{\partial {ϕ}_{1}}{\partial x} & \frac{\partial {ϕ}_{2}}{\partial x} & \frac{\partial {ϕ}_{3}}{\partial x} \\ \frac{\partial {ϕ}_{1}}{\partial y} & \frac{\partial {ϕ}_{2}}{\partial y} & \frac{\partial {ϕ}_{3}}{\partial y}\end{matrix} ]$$

where φᵢ refers to the elements' shape (trail) functions, defined by,
φ₁=ξ
φ₂=η
φ₃=1−ξ−η
Where ξ and η refer to the element intrinsic coordinates in the range of 0 to 1. More details are provided in Zienkiewicz et al. 2000. The Finite Element Method, vol. 1, published by CIMNE, the International Centre for Numerical Methods in Engineering, Barcelona, Spain.

The explicit B matrix for a heat transfer 2D linear triangular element is given by,

$$B = \frac{1}{\vert J \vert} [ \begin{matrix}{y}_{2} - {y}_{3} , & {y}_{3} - {y}_{1} , & {y}_{1} - {y}_{2} \\ {x}_{3} - {x}_{2} , & {x}_{1} - {x}_{3} , & {x}_{2} - {x}_{1}\end{matrix} ]$$

where |J| refers to the determinant of the Jacobean matrix, J, and is given by,
|J|=(x₁−x₃)(y₂−y₃)−(y₁−y₃)(x₂−x₃)
where (xᵢ, yᵢ) refer to the elements nodes coordinates. The conductivity matrix, C, for an isotropic material is given by,

$$[ \begin{matrix}{C}_{x} & 0 \\ 0 & {C}_{y}\end{matrix} ]$$

where Cₓ and C_{y} are the material thermal conductivity parameters in the x and y directions, respectively.

For each element, the B matrix defined above, is calculated in a fragment shader on the GPU using one rendering pass. The multiplication of the B transpose, C and B matrices to form the element equation matrix can be performed in the same rendering pass or as an additional rendering.

The integration over each element is performed using the Gauss Quadrature integration. The Gauss Quadrature integration is explained in greater detail in Zienkiewicz et al. 2000. The Finite Element Method, vol. 1, published by CIMNE, the International Centre for Numerical Methods in Engineering, Barcelona, Spain. That is,

$${K}^{e} = {\int }_{e} {B}^{T} C B ⅆ e = {\sum }_{i = 1}^{n} {B}_{i}^{T} C {B}_{i} \vert {J}_{i} \vert {W}_{i}$$

where n is the number of Gauss points, i, used for the integration, B^{T}ᵢ, Bᵢ and Jᵢ are the B transpose matrix, the B matrix and Jacobean evaluated at a given Gauss point i, and Wᵢ is the weight factor associated with Gauss point i. The locations of the Gauss points and weight factors are specified in mathematical tables and can be stored in constant arrays provided to the GPU shaders. The number of Gauss points in each element is defined according to the element type and the required accuracy. The contribution of each Gauss point values to the elements matrices are accumulated into the elements matrices texture, resulting in complete elements matrices.

B.3 Applying the Boundary Conditions

Specified heat sources/sinks are applied to the system by adding their values directly to the corresponding right hand side flux vector's element. That is, the right hand side, F, vector in the Ku=F system. There is no need to solve for nodes that their specified temperature is provided. These nodes are omitted from the calculation by setting the Z-buffer mask for the corresponding vectors' elements such that there will be no rendering of these pixels. That is, the corresponding vector elements are omitted from the calculations.

B.4 Solving the Linear Systems of Equations

The resulting system of linear equations is then solved using the iterative Conjugate Gradients method, as described in Golub et al., Matrix Computations, 3rd ed. The Johns Hopkins University Press, 1996. The implementations of the conjugate gradients method requires only two non-trivial operations: a matrix-vector multiply and a vector inner product. The matrix-vector multiply is described below and the vector inner product is described by Krüeger et al., Linear Algebra Operators for GPU Implementation of Numerical Algorithms. ACM SIGGRAPH 2003: 27-31 Jul. 2003, San Diego, Calif.

B.5 Multiplying the Stiffness Matrix by a Vector

An element-by-element approach, which is known to those skilled in the art and such as described in Smith et al. Programming The Finite Element Method, 3^{rd} edition. John Wiley and Sons, Inc. 2003, the disclosure of which is fully incorporated herein by reference, may be used for solving the linear system resulted from the elements matrices. This approach reduces the memory footnotes of the calculation and eliminates the assembly of the general stiffness matrix.

For fast processing of this calculation step, an in-element look-up table, which contains all the elements a given node belongs to, is stored on the GPU and provided as an input texture to the fragment program. The in-element look-up table is used to process all the elements belonging to this node, multiplying the relevant part of the element's matrix by the corresponding element in the specified input vector, and to add the value to the corresponding output vector's element.

We now define some of the terminology used herein:
(1) domain: the region in space occupied by the system the problem is defined on;
(2) element: a simply-shaped region that together with other simply-shaped regions form the domain;
(3) node: the common endpoint of two sides of an element;
(4) mesh: the ensemble of nodes and elements generated by the division of the problem domain into small, simply-shaped regions called elements (for example, triangle, quadrilateral, or tetrahedral);
(5) node coordinate: physical location of the node;
(6) element connectivity information: indexes (i.e., nodes numbers) to the nodes forming the element;
(6) material property: the physical properties defining the material forming the domain (for example, the thermal conductivity of the domain material);
(7) boundary condition: loads acting on the boundary of the domain (for example, location of the domain that is kept in constant temperature, heat flux applied to the domain, and the like);
(8) element equation (matrix): the transformed problem's equation for the element's sub-domain into algebraic form; also called the element matrix; and
(9) global matrix: the assembly of an element's equations from all of the elements into a “big” linear system of equations for the entire domain; also called the global system.

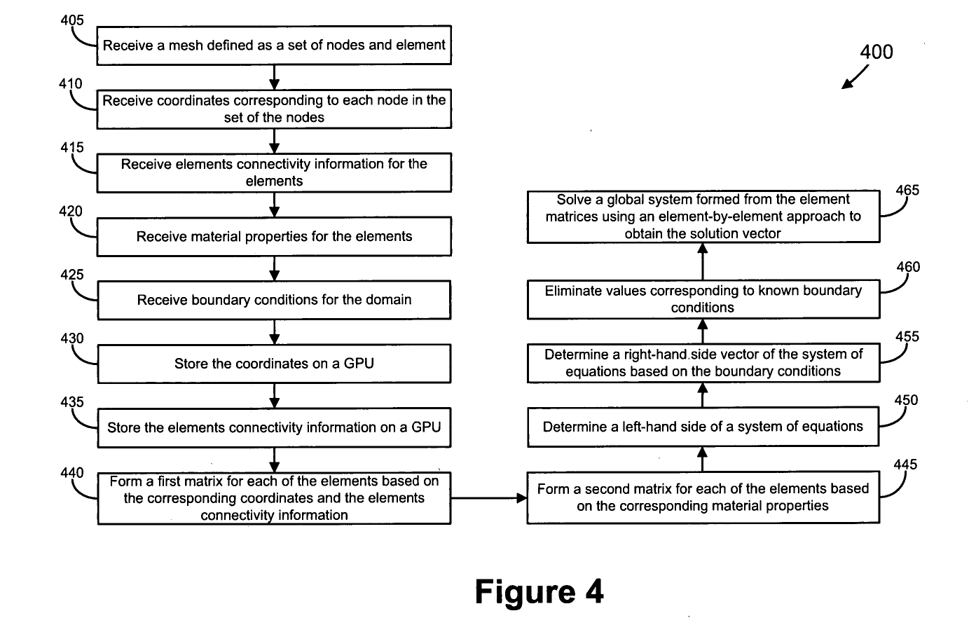

Referring now to FIG. 4, an exemplary method for performing the Finite Element method is shown, in accordance with one embodiment of the present invention. A mesh defined as a set of nodes and elements is received (at 405). Coordinates corresponding to each node in the set of the nodes is received (at 410). Elements connectivity information for the elements is received (at 415). Material properties for the elements are received (at 420). Boundary conditions for the domain are received (at 425). The coordinates are stored (at 430) on a graphics processing unit (GPU). The elements connectivity information are stored (at 435) on the GPU. A first matrix is formed (at 440) for each of the elements based on the corresponding coordinates and the corresponding elements connectivity information. A second matrix is formed (at 445) for each of the elements based on the corresponding material properties. A left-hand side of a system of equations is determined (at 450). The left hand side comprises an element equation matrix based on a sum of the products of the transpose of the first matrix, the second matrix, and the first matrix. The right-hand side vector of the system of equations is determined (at 455) based on the boundary conditions. Values corresponding to known boundary conditions are eliminated (at 460) from the element equation matrices using a Z-buffer mask. A global system formed from the element matrices is solved (at 465) using an element-by-element approach to obtain the solution vector. The solving step (at 465) and eliminating step (at 460) may be performed simultaneously.

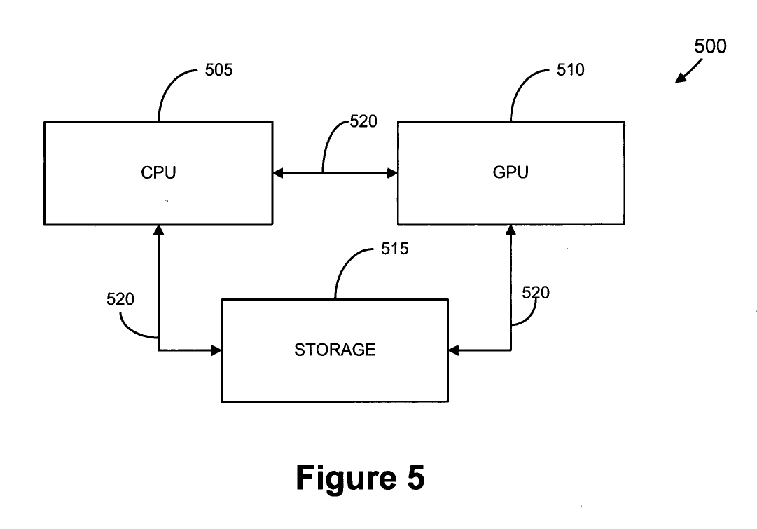

Referring now to FIG. 5, a system for performing the Finite Element Method is shown. The system includes a CPU 505, a GPU 510 and a storage 515, each of which are operatively connected through, for example, a system bus 520. The storage 515 may include any of a variety of data storage devices, as contemplated by those skilled in the art. The CPU 505 is adapted to transfer a set of nodes from the storage 515 to the GPU 510. The GPU 510 is adapted to perform the Finite Element Method on the set of nodes.

The particular embodiments disclosed above are illustrative only, as the invention may be modified and practiced in different but equivalent manners apparent to those skilled in the art having the benefit of the teachings herein. Furthermore, no limitations are intended to the details of construction or design herein shown, other than as described in the claims below. It is therefore evident that the particular embodiments disclosed above may be altered or modified and all such variations are considered within the scope and spirit of the invention. Accordingly, the protection sought herein is as set forth in the claims below.

1. A computer-implemented method for performing the Finite Element Method, comprising:
receiving a mesh defined as a set of nodes and elements;
storing the coordinates on a graphics processing unit (GPU), the coordinates corresponding to each node in the set of nodes;
storing the elements connectivity information on the GPU, the elements connectivity information for the elements;
forming a first matrix for each of the elements based on the corresponding coordinates and the elements connectivity information;
forming a second matrix for each of the elements based on corresponding material properties;
determining a left-hand side of a system of equations for each of the elements, the left-hand side comprising an element matrix based on a sum of the products of a transpose of the first matrix, the second matrix, and the first matrix;
determining a right-hand side of the system of equations for the each of the elements based on boundary conditions, wherein the left hand-side and the right hand side for all of the elements form a global system;
eliminating values corresponding to known boundary conditions from the global system using a Z-buffer mask; and
solving the global system.

2. The method of claim 1, wherein the steps of solving and eliminating are performed simultaneously.

3. The method of claim 1, wherein the mesh is received simultaneously with the corresponding coordinates.

4. The method of claim 1, wherein the elements are received simultaneously with the elements connectivity information.

5. The method of claim 1, wherein the step of storing the coordinates in a GPU, comprises:
storing the coordinates in a floating-point RGB texture of the GPU.

6. The method of claim 1, wherein the step of storing the elements connectivity information in the GPU, comprises:
storing the elements connectivity information in one of a RGB texture and a RGBA texture of the GPU.

7. The method of claim 1, wherein the step of forming a first matrix, comprises:
forming a Stiffness Matrix.

8. The method of claim 1, wherein the step of forming a second matrix, comprises:
forming a conductivity matrix.

9. The method of claim 1, wherein the step of solving the global system comprises:
solving the global system using an element-by-element approach.

10. The method of claim 9, wherein the step of solving the global system using an element-by-element approach, comprises:
solving the global system using a conjugate gradients method.

11. The method of claim 10, wherein the step of solving the global system using a conjugate gradients method, comprises:
multiplying the global system by a vector.

12. A system for performing the Finite Element Method, comprising:
a central processing unit (CPU);
a memory operatively connected to the CPU; and
a graphics processing unit (GPU) operatively connected to the CPU;
wherein the CPU transfers a set of nodes and elements from the memory to the GPU, the set of nodes and the elements forming a mesh; and
wherein the GPU performs the Finite Element Method on the set of nodes and the elements.

13. A program storage device readable by a machine, tangibly embodying a program of instructions executable on the machine to perform method steps for performing the Finite Element Method, the method comprising the steps of:
transferring a set of nodes and elements from a memory to a graphics processing unit (GPU), the set of nodes and the elements forming a mesh; and
performing the Finite Element Method on the set of nodes and the elements using only the GPU.
